(19) United States
(12) Patent Application Publication
(10) Pub. No.: US 2002/0053990 A1
(43) Pub. Date: May 9, 2002

(54) Cellular-phone apparatus and antenna used for this

(76) Inventor: Takeshi Ikeda, Tokyo (JP)

Correspondence Address: Burton A. Amernick, Connolly Bove Lodge & Hutz LLP, Suite 800, 1990 M Street, N.W., Washington, DC, 20036-3425, US

(21) Appl. No.: 09/962,203

(22) Filed: Sep. 26, 2001

(30) Foreign Application Priority Data
Sep. 27, 2000 (JP) 2000-293301

(51) Int. Cl. H01Q 1/24

(52) U.S. Cl. 343/702; 343/901

(57) ABSTRACT

The antenna 1 is formed in such a manner that the antenna top portion 2 covers a guide portion 4 when the antenna 1 is engaged at a predetermined position so that the rainwater and the like are not allowed water penetration into the inside of the case body 3 of the cellular-phone apparatus via the through hole 113 and the damage of the electric circuits in the inside of the case body 3 is effectively prevented, and, at the same time, even when the device is used while the antenna 1 is housed in the inside of a case body 3, no member is arranged around the antenna top portion 2, which prevents sending/receiving of the signal, so as to be able to maintain a good receiving sensitivity of the signal.

### BACKGROUND OF THE INVENTION

1. Field of the Invention

The present invention relates to a cellular-phone apparatus and an antenna for this and, more in particular, to a retractable antenna of the cellular-phone apparatus and its hold structure.

2. Description of the Related Art

A cross-sectional structure of the antenna portion used in the conventional cellular-phone apparatus is shown in FIG. 1. As shown in FIG. 1, the conventional antenna 100 comprises an antenna top portion 101 (antenna main body) with a cross-sectional shape being circular and an antenna element 102. The antenna element 102 has in its inside an axis center (not shown) made of steel wire and is constituted by covering it with an antenna tube made of plastic.

At both ends of this antenna element 102, two stoppers having an outside diameter larger than that of the antenna element 102, that is, a top stopper 103 and a bottom stopper 104 are provided. The top stopper 103 and the bottom stopper 104 are also circular in the cross-sectional shape, and the outside diameters thereof are nearly the same with each other.

On the other hand, in a case body 110 of the a cellular-phone apparatus, a first cylindrical guide portion 111 with both ends thereof opened is formed. An inside diameter of a cylinder of the first guide portion 111 is formed slightly larger than an outside diameter of the antenna top portion 101. Further, in the inside of the first guide portion 111, a second cylindrical guide portion 112 with both ends thereof opened is provided.

The second guide portion 112 has the outside diameter smaller than that of the first guide portion 111, and a part of an outer periphery of the second guide portion 112 is inscribed in a part of an inner periphery of the first guide portion 111. Further, the inside diameter of a cylinder of this second guide portion 112 is formed slightly larger than the outside diameter of the top stopper 103.

By the opening portions owned by these first guide portion 111 and second guide portion 112, a through hole 113 is formed between the inside and the outside of the case body 110. The antenna 100 is movably inserted into the throughhole 113 formed by this first and second guide portions 111, 112.

One end (inner portion side of the case body 110) of the second guide portion 112 is formed so as to become slightly smaller in an outside diameter than each stopper 103, 104 and an elastic portion 114 is formed therein. In this way, when each stopper 103, 104 abuts against the elastic portion 114 by the movement of the antenna 100, each stopper 103, 104 is held by an adequate force by the elastic portion 114.

That is, when the antenna 100 is used by pulling it out from the case body 110, the bottom stopper 104 is held by the elastic portion 114 of the second guide portion 112 so that the antenna 100 can be held in a pulled out state. On the other hand, when the antenna 100 is housed in the inside of the case body 110, the top stopper 103 is held by the elastic portion 114 of the second guide portion 112. On this occasion, the antenna top portion 101 has its downward portion housed in a hollow portion of the first guide portion 111.

As described above, in the conventional cellular-phone apparatus telephone device, when a first convex guide portion 111 was provided for the case body 110 and the antenna 100 was housed in the interior of the case body 110, a part of the antenna top portion 101 has been housed within the first guide portion 111. This is to prevent the damage of the antenna top portion 101 upon receipt of an external pressure by covering a periphery of the antenna top portion 101 with the first guide portion 111, which has a relatively strong strength.

However, in such a structure, when the cellular-phone apparatus is used, for example, in a rainy day, there has been a problem that the rainwater comes into the inside of the case body 110 from a gap between the antenna top portion 101 and the first guide portion 111 via the through hole 113. In the inside of the case body 110, various electric circuits including print circuit substrates not shown are provided, and with the rainwater seeping here, the life of the cellular-phone apparatus has sometimes been shortened.

Further, the cellular-phone apparatus is sometimes used while the antenna 100 is housed in the inside of the case body 110. However, in this case, since the first guide portion 111 is arranged on the periphery of the housed antenna top portion 101, in certain cases, this becomes a cause of reducing the receiving sensitivity of a signal and, in the worst case, a problem sometimes occurred that communications come to be cut off.

### SUMMARY OF THE INVENTION

The present invention has been carried out in order to solve such a problem and it is an object of the present invention to be able to effectively prevent water penetration into the inside of the case body and at the same time maintain a good receiving sensitivity even in a state of the antenna being housed in the inside of the case body of the cellular-phone apparatus.

In order to achieve the above described object, the cellular-phone apparatus of the present invention comprises an antenna for sending/receiving a signal and a guide portion in which the above described antenna is movably inserted along an inner wall, wherein the above described antenna is formed in such a manner that the main body of the above described antenna covers the above described guide portion when the above described antenna is engaged at a predetermined position.

In the other mode of the present invention, the main body of the above described antenna is a member with a bottom cross-section being circular, and the above described guide portion is a cylindrical member having a hollow portion, and an outside diameter of the bottom cross-section of the main body of the above described antenna is made larger than the outside diameter of the above described guide portion.

In another mode of the present invention, the main body of the above described antenna has a concave portion which engages with the above described guide portion.

In another mode of the present invention, the above described guide portion includes a member in which a part of the case body of the above described cellular-phone is formed in a convex shape.

In another mode of the present invention, the above described guide portion is a member which is formed such that at least a part thereof is projected from the case body of the above described cellular-phone apparatus.

In another mode of the present invention, the above described guide portion has an engagement mechanism for engaging the above described antenna at a predetermined position.

Further, the antenna of the cellular-phone apparatus according to the present invention is an antenna which is movably inserted along the inner wall of the guide portion formed in the cellular-phone apparatus and sends/receives a signal, wherein the main body of the above described antenna is formed so as to cover the above described guide portion when the above described antenna engages at a predetermined position.

In another mode of the present invention, the outside diameter of the bottom cross-section of the main body of the above described antenna is formed larger than the outside diameter of the above described cylindrical guide portion having the hollow portion.

In another mode of the present invention, the main body of the above described antenna has a concave portion which engages with the above described guide portion.

Since the present invention comprises the above described technological means, the through hole between the outside and the inside of the case body of the cellular-phone apparatus formed by the guide portion is covered and concealed by the main body of the antenna and so, even when the cellular-phone apparatus is used in a rainy day, the rainwater is not allowed to come into the inside of the case body via the through hole, thereby effectively preventing the damage of the electric circuits in the inside of the case body. Further, even when the device is used while the antenna is in a state of being housed in the inside of the case body, since there is no member arranged at all around the main body of the antenna, which prevents sending/receiving of a signal, a good receiving sensitivity of the signal can be maintained.

### BRIEF DESCRIPTION OF THE DRAWINGS

FIG. 1 is a cross-sectional view showing a constitution of the conventional cellular-phone apparatus;

FIGS. 2A to 2C are cross-sectional views showing constitutional examples of the cellular-phone apparatus according to a first embodiment; and

FIG. 3 is a cross-sectional view showing a constitutional example of the cellular-phone apparatus according to a second embodiment.

### DETAILED DESCRIPTION OF THE PREFERRED EMBODIMENTS

An embodiment of the present invention will be described below with reference to the drawings.

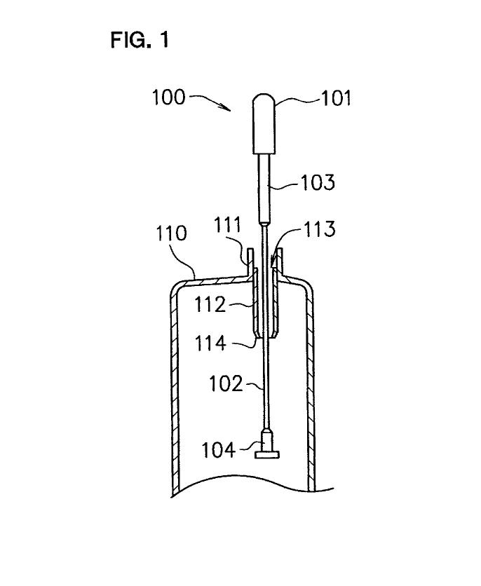

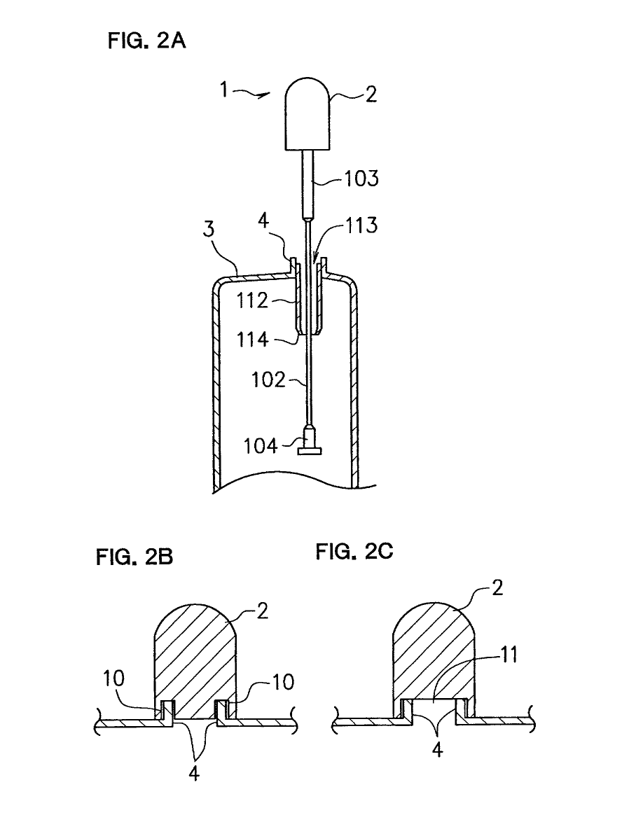

FIG. 2 is a cross-sectional view showing a constitutional example of a cellular-phone apparatus according to a first embodiment, FIG. 2A shows the whole cross-section of an antenna and its hold structure, and FIG. 2B and FIG. 2C are partially enlarged cross-sectional views at a time when the antenna is housed in the inside of the case body. Incidentally, in FIG. 2, the same components as the components shown in FIG. 1 are specified with the same reference numerals, and the repetitive description thereof will be omitted here.

As shown in FIG. 2A, in the present embodiment, a first cylindrical guide portion 4 with both ends thereof opened is formed for the case body 3 of the cellular-phone apparatus. Although this first guide portion 4 is formed short in the length of the cylinder compared to the conventional first guide portion 111, this is not indispensable for the present invention and the length of the cylinder may be formed equal to or longer than that of the conventional first guide portion 111.

Further, the antenna 1 of the present embodiment is provided with an antenna top portion (antenna main body) 2 with the cross-sectional shape being circular. The outside diameter of this antenna top portion 2 is formed larger than the outside diameter of the cylinder of the first guide portion 4. For example, the outside diameter of the first guide portion 4 is allowed to be the same as that of the conventional first guide portion 111, and the outside diameter of the antenna top portion 2 is formed larger than that. Being formed in such a manner, the antenna top portion 2 is placed in a state of covering the first guide portion 4 from the outside at the time when the antenna 1 is housed. The views showing such a state are FIG. 2B and FIG. 2C.

FIG. 2B and FIG. 2C show two examples of two structures of the antenna top portion 2. FIG. 2B shows a view in which a concave ring groove 10 is formed in the antenna top portion 2 so that the first guide portion 4 projecting from the case body 3 exactly engages with it when the antenna 1 is housed in the inside of the case body 3. In other words, a circumferential portion, which is about or a base of the antenna top portion 2, and an inner circle portion inside from there by a predetermined diameter are formed in a convex shape.

Further, the antenna top portion 2 of FIG. 2C is such that the inner circle portion inside from the outer periphery of the antenna top portion 2 by a predetermined diameter is formed by a concave circular groove 11. In other words, the circumferential portion about on a base of the antenna top portion 2 is formed in a convex shape.

In either case of FIG. 2B and FIG. 2C, even when an external force is applied to the antenna top portion 2, the antenna top portion 2 is held by the first guide portion 4, and the damage of the antenna 1 can be prevented.

Further, according to the present embodiment constituted in such a manner, since the through hole 113 is covered and concealed by the antenna top portion 2, even when the cellular-phone apparatus is used in a rainy day, it is possible that no rainwater is allowed to penetrate in the inside of the body case 3 via the through hole 113. In this way, an inconvenience of damaging the electric circuits in the inside of the body case 3 by the seeping rainwater and the like can be prevented.

Furthermore, according to the present embodiment, even when the cellular-phone apparatus is used while the antenna 1 is housed in the case body 3, since there is no member arranged at all around the antenna top portion 2, which prevents sending/receiving of a signal, a good receiving sensitivity of the signal can be maintained. Further, in the present embodiment, since the antenna top portion 2 itself is formed larger than compared to the conventional antenna top portion 101, a large scale highly accurate antenna can also be used, thereby raising a receiving sensitivity.

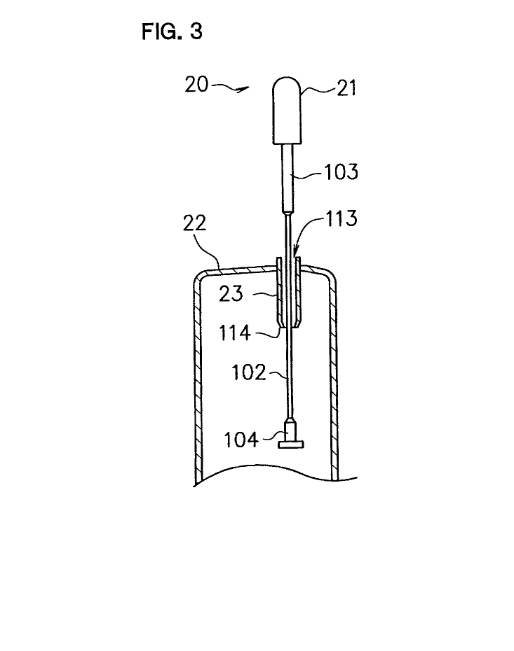

FIG. 3 is a cross-sectional view showing a constitutional example of a cellular-phone apparatus according to a second embodiment. In this FIG. 3, the same components as the components shown in FIG. 2 are attached with the same reference numerals, and the repetitive description thereof will be omitted.

As shown in FIG. 3, in the present embodiment, the cylindrical guide portion as described in the first embodiment is not provided for a case body 22 of the cellular-phone apparatus. Instead of that, one end of a second guide portion 23 is projected outside of the case body 22 by a predetermined amount (for example, the same level as the projected amount of the first guide portion 4 described in the first embodiment).

Further, an outside diameter of an antenna top portion (antenna main body) 21 provided for an antenna 20 of the present embodiment is formed larger than the outside diameter of a second guide portion 23. For example, the outside diameter of the second guide portion 23 is made the same as that of the conventional second guide portion 112, and the outside diameter of the antenna top portion 21 is made larger than that. Being formed in such a manner, the antenna top portion 21 is placed in a state of covering a portion projected outside of the case body 22 of the second guide portion 23 from the outside when the antenna 20 is housed.

Even in the second embodiment formed in such a manner, similarly to the first embodiment, even when an external pressure is applied to the antenna top portion 21, the antenna top portion 21 is held by the second guide portion 23, and the damage of the antenna 20 can be prevented. Further, since the through hole 113 is covered and concealed by the antenna top portion 21, the rainwater is not allowed to come into the inside of the case body 22 via the through hole 113 and therefore it is possible to prevent the damage of the electric circuits in the inside of the case body 22 due to the water penetration.

Furthermore, according to the present embodiment, even when the cellular-phone apparatus is used while the antenna 20 is housed in the case body 22, since there is no member arranged at all around the antenna top portion 21, which prevents sending/receiving of a signal, a good receiving sensitivity of the signal can be maintained. Further, in the present embodiment, since no constitution equivalent to the first guide portion 4 is required to be formed in the case body 22, the production of the case body 22 is made simple compared to the conventional one and the production cost thereof can also be reduced.

Note that the shape and structure of each component shown in the above described embodiments only show one example of the embodiments in executing the present invention, and the technological scope of the present invention should not be understood to be limited by these embodiments. That is, the present invention can be executed in various forms without departing from the sprit or the essential characteristics of the invention.

What is claimed is:

1. A cellular-phone apparatus, comprising:
an antenna for sending/receiving a signal; and
a guide portion in which said antenna is movably inserted along an inner wall,
wherein said antenna is formed in such a manner that a main body of said antenna covers said guide portion when said antenna is engaged at a predetermined position.

2. The cellular-phone apparatus according to claim 1, wherein the main body of said antenna is a member with a bottom cross-section being circular, and said guide portion is a cylindrical member having a hollow portion, and an outside diameter of the bottom cross-section of the main body of said antenna is made larger than an outside diameter of said guide portion.

3. The cellular-phone apparatus according to claim 1, wherein the main body of said antenna has a concave portion which engages with said guide portion.

4. The cellular-phone apparatus according to claim 1, wherein said guide portion includes a member in which a part of a case body of said cellular-phone apparatus is formed in a convex shape.

5. The cellular-phone apparatus according to claim 1, wherein said guide portion is a member which is formed such that at least one part thereof is projected from a case body of said cellular-phone apparatus.

6. The cellular-phone apparatus according to claim 1, wherein said guide portion has an engagement mechanism for engaging said antenna at a predetermined position.

7. An antenna which is movably inserted along an inner wall of a guide portion formed in a cellular-phone apparatus and sends/receives a signal,
the antenna of the cellular-phone apparatus, wherein a main body of said antenna is formed so as to cover said guide portion when said antenna engages at a predetermined position.

8. The antenna of the cellular-phone apparatus according to claim 7, wherein an outside diameter of a bottom cross-section of the main body of said antenna is formed larger than an outside diameter of said cylindrical guide portion having a hollow portion.

9. The antenna of the cellular-phone apparatus according to claim 7, wherein the main body of said antenna has a concave portion which engages with said guide portion.
